(19) United States
(12) Patent Application Publication
(10) Pub. No.: US 2024/0324639 A1
(43) Pub. Date: Oct. 3, 2024

(54) One-Piece Sandwich Potato Chip

(71) Applicant: Michael Vazquez, Holtsville, NY (US)

(72) Inventor: Michael Vazquez, Holtsville, NY (US)

(21) Appl. No.: 18/610,429

(22) Filed: Mar. 20, 2024

Related U.S. Application Data
(60) Provisional application No. 63/493,029, filed on Mar. 30, 2023.

(51) Int. Cl. A23L 19/18; A23L 27/00

(52) U.S. Cl. CPC A23L 19/19; A23L 27/00

(57) ABSTRACT

A potato chip specifically designed to be used as a sandwich or hamburger flavor layer. The chip is sized to fit within the perimeter of the bread or bun, with no overhang or protrusion, resulting in a desirable sandwich chip-to-bread ratio and a consistent distribution of ingredients across all portions of the sandwich. The potato chip is made from a potato paste that can be flavored with a wide range of flavors, such as salted, sour cream and onion, barbecue, cheese and onion, spicy jalapeno, ranch, and more. In one embodiment, a method of making the potato chip is disclosed which involves preparing the potato paste, extruding it into the desired shape and size, drying it, and seasoning it with different flavors.

### CROSS-REFERENCE TO RELATED APPLICATION

The present application claims priority to, and the benefit of, U.S. Provisional Application No. 63/493,029, which was filed on Mar. 30, 2023 and is incorporated herein by reference in its entirety.

### FIELD OF THE INVENTION

The present invention generally relates to the field of potato chips and sandwiches. More specifically, the present invention relates to a novel sandwich/bread/bun-sized snack chip designed to be slightly smaller than a slice of bread so that the chip lies on the sandwich without hanging over the bread. The chip is easy to place in a sandwich and prevents the mess that occurs from piling traditional potato chips on a sandwich. Accordingly, the present disclosure makes specific reference thereto. Nonetheless, it is to be appreciated that aspects of the present invention are also equally applicable to other like applications, devices, and methods of manufacture.

### BACKGROUND

By way of background, adding potato chips to a snack item such as a sandwich is a popular way to add texture and flavor. The potato chips provide a crunchy texture that complements the softness of the bread and the meat or other fillings. Potato chips are known for their crispy and crunchy texture, thus when added to a sandwich, they provide a satisfying crunch that contrasts with the softer texture of the bread and fillings. Further, potato chips add some extra flavor and texture to a sandwich without requiring additional preparation. However, there are some challenges associated with adding conventional potato chips to a sandwich.

When conventional potato chips are added on top of the sandwich fillings, they commonly slide around or fall out of the sandwich as the sandwich is assembled. This can make the sandwich look uneven and unappetizing, and it can also be frustrating for the person trying to assemble the sandwich. Also, when potato chips are added to a sandwich, they can break into small pieces that fall out of the sandwich as it is being eaten. This can be messy and inconvenient and can also detract from the overall eating experience.

Further, traditional potato chips are thin, flat, and oval-shaped and a plurality of these potato chips must be added to the sandwiches for the chip enhancement. Manually adding traditional chips in sandwiches does not maintain an ideal meat to chip ratio. Inconsistent amount of chips is generally encountered in each bite which reduces overall eating experience. Individuals desire an improved potato chip for sandwiches and other similar snack items that is designed to fit on a sandwich.

Therefore, there exists a long felt need in the art for a sandwich-sized potato chip. There is also a long felt need in the art for a sandwich/bread/bun-sized snack chip that is specifically designed to fit on a sandwich or between bread slices or between bun halves. Additionally, there is a long felt need in the art for a potato chip that provides consistent and perfect meat to crunch ratio in a sandwich. Moreover, there is a long felt need in the art for an improved potato chip that is easy to add to a sandwich without any breakage or mess. Further, there is a long felt need in the art of a sandwich-sized potato chip that is less likely to break into small pieces that fall out of the sandwich during eating of the sandwich. Furthermore, there is a long felt need in the art for an improved sandwich/bread/bun-sized snack chip that comes in a variety of shapes and sizes to accommodate different sandwich types. Finally, there is a long felt need in the art for a sandwich chip that offers a convenient and enjoyable way to add crunch to a sandwich or any other type of bread/bun without the challenges associated with traditional chips.

The subject matter disclosed and claimed herein, in one embodiment thereof, comprises a sandwich or bread-sized flavored potato chip. The potato chip is designed to be layered on a sandwich or other type of snack items such as hamburgers, rolls, subs/heros, and others, to add the crunch of a chip to the sandwich and obtain the perfect meat to crunch ratio. The potato chip has a one-piece construction and further comprises a top surface and an opposite bottom surface, the surfaces being substantially flat, parallel and identical in texture and taste, the potato chip is sized to substantially cover the surface of the bread without exceeding a bread's perimeter to prevent hanging of the chip from the sandwich or other snack, the potato chip having a first thickness around the (i.e.., proximal to) central area of the chip, and a second thickness in the remaining area of the chip, wherein the first thickness is more than the second thickness for providing adequate filling or meat to chip ratio.

In this manner, the sandwich/bread-sized potato chip of the present invention accomplishes all of the forgoing objectives and provides users with a bread-sized potato chip that can be layered on the sandwich. The chip comes in different sizes and shapes for different bread types and provides perfect meat to crunch ratio. The chip prevents the mess that occurs from piling traditional potato chips onto a sandwich during making and eating of the sandwich.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a one-piece sandwich or bread-sized potato chip. The potato chip is designed to be layered on a sandwich or other type of snack items such as hamburgers, rolls, and subs/grinders/heros. The potato chip further comprising a top surface and a bottom surface, the surfaces being parallel and identical in texture and taste, the potato chip is sized to substantially cover the area defined by the bread/bun without exceeding bread's/bun's perimeter, the potato chip having standard dimensions of, for example, 3.5″×3.0″, 3.5″×3.5″, 4.0″×4.0″, 3.0″ diameter, 3.5″ diameter, 4.0″ diameter, and a first thickness around the (i.e.., proximal to) central area of the chip, and a second thickness in the remaining area of the chip, wherein the first thickness is more than the second thickness for providing adequate filling or meat to chip ratio, the top surface of the chip having a logo or indicia embossed thereon for providing branding and marketing for manufacturers, wherein the potato chip is made of potato paste and available in different flavors.

In yet another embodiment, a sandwich product is disclosed. The sandwich product comprising a top bread slice/bun, a bottom bread slice/bun, a meat stack or a filling material sandwiched between the top and bottom breads, a bread-sized potato chip positioned between the meat stack and top bread, wherein the potato chip has a top surface and a bottom surface and is dimensioned and configured to occupy a substantial portion of the surface area of the top and bottom breads without exceeding their respective perimeters, and to maintain a consistent distribution of ingredients across all portions of the sandwich.

In yet another embodiment, the potato chip is positioned in a face-to-face relation with the bottom surface of the top bread slice/bun and with the meat stack, thereby providing a desirable sandwich chip-to-bread ratio and an aesthetically pleasing appearance.

In a further embodiment, a potato chip designed for use with hamburgers, the chip being generally circular and substantially flat, and having a uniform thickness is disclosed. The potato chip, in one exemplary arrangement, further comprising a top surface and an opposite and identical bottom surface, wherein the potato chip models the shape of a hamburger bun, and the peripheral edge of the potato chip is designed not to exceed the outer edge of the bun, the potato chip is made of potato paste, and can be flavored with any of a variety of flavors including, but not limited to, classic salted, sour cream and onion, barbecue, cheese and onion, spicy jalapeno, ranch, salt and vinegar, chili cheese, honey mustard, garlic and herb, truffle, smoky bacon, wasabi, dill pickle, hot and spicy, and the like.

In a further embodiment, a method for preparing potato chips designed for sandwiches and other snack items is described. The method includes the steps of preparing a potato paste by mixing potato flour, water, salt, oil, and spices and adding a desired flavoring agent to the potato paste, heating and extruding the potato paste through a die or mold to give it a desired shape and size, wherein the shape is of a bread slice (i.e.., rectangular) or bun (i.e., circular or oblong) used for making a snack item, drying the extruded chips in an oven or a fryer to remove excess moisture and to give them a crispy texture, seasoning the potato chips with various flavors, and packaging the potato chips in bags or containers.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a sandwich snack chip of the present invention in accordance with the disclosed architecture;

FIG. 2 illustrates a perspective view of a sandwich product having the potato or snack chip of FIG. 1 as a layer therein in accordance with the disclosed architecture;

FIG. 3 illustrates a perspective view of another embodiment of the sandwich bread-sized or bun-sized potato or snack chip of the present invention in accordance with the disclosed architecture;

FIG. 4 illustrates a perspective view of a hamburger product having the potato or snack chip of FIG. 3 as a layer therein in accordance with the disclosed architecture; and

FIG. 5 illustrates a flow diagram depicting a process of making sandwich, bread-sized, or bun-sized snack potato chips of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a sandwich-sized potato chip. There is also a long felt need in the art for a sandwich/bread/bun-sized snack chip that is specifically designed to fit on a sandwich, a bread, or a bun. Additionally, there is a long felt need in the art for a potato chip that provides consistent and perfect meat to crunch ratio in a sandwich. Moreover, there is a long felt need in the art for an improved potato chip that is easy to add to a sandwich without any breakage or mess. Further, there is a long felt need in the art of a sandwich-sized potato chip that is less likely to break into small pieces that fall out of the sandwich during eating of the sandwich. Furthermore, there is a long felt need in the art for an improved sandwich/bread/bun-sized snack chip that comes in a variety of shapes and sizes to accommodate different sandwich types. Finally, there is a long felt need in the art for a sandwich chip that offers a convenient and enjoyable way to add crunch to a sandwich or any other type of bread/bun without the challenges associated with traditional chips.

The present invention, in one exemplary embodiment, is a sandwich product having a one-piece potato chip layered therein. The sandwich product includes a top bread/bun slice, a bottom bread/bun slice, a meat stack or any other filling material sandwiched between the top and bottom breads/buns, a bread/bun-sized potato chip positioned between the meat stack and top bread/bun, wherein the potato chip has a top surface and a bottom surface and is dimensioned and configured to occupy a substantial portion of the surface area of the top and bottom breads/buns without exceeding their respective perimeters, and to maintain a consistent distribution of ingredients across all portions of the sandwich.

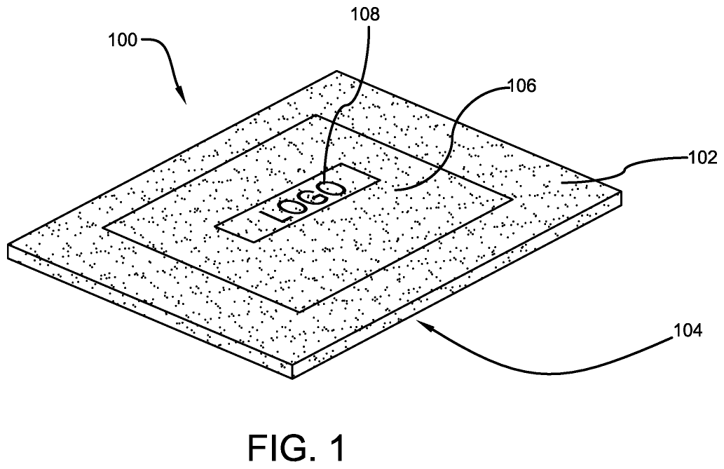

Referring initially to the drawings, FIG. 1 illustrates a perspective view of one potential embodiment of a sandwich snack chip of the present invention in accordance with the disclosed architecture. The sandwich snack chip 100 of the present invention is designed as a sandwich or bread/bun-sized snack potato chip to be layered on a sandwich or other types of sandwich items such as hamburgers, rolls, subs, grinders, and heros. The snack chip 100 is a one-piece chip and is slightly smaller than a slice of bread so that the chip 100 lies on the sandwich without hanging over the bread. More specifically, the chip 100 has a top surface 102 and a bottom surface 104, the surfaces 102, 104 are parallel and identical in texture and taste. Preferably, the snack chip 100 is made of potato paste and can come in different flavors. The potato chip 100 is sized to substantially cover the surface of the bread used for making sandwich or other snack item, without exceeding bread's perimeter.

In the preferred embodiment, the snack potato chip 100 has standard dimensions of, for example, 3.5″×3.0″, 3.5″×3.5″, 4.0″×4.0″, 3.0″ diameter, 3.5″ diameter, 4.0″ diameter, and is slightly denser than a traditional potato chip to achieve the ideal crunch and texture. In the preferred embodiment, the snack potato chip 100 has a thickness of about 0.5″-0.75″ around the (i.e.., proximal to) central area 106 of the chip 100 and can have a thickness of about 0.25″-0.5″ in the remaining area. The central area 106 is denser than an edge area for providing adequate filling or meat to chip ratio. In other embodiments, the snack potato chip 100 can have uniform thickness throughout the entire surface thereof.

The top surface 102 also can have a logo or indicia 108 embossed thereon for providing branding and marketing for manufacturers. The sandwich snack chip 100 is specifically designed to be added to sandwiches and other snack items for added crunch and flavor and can be made in different shapes and sizes for different types of bread.

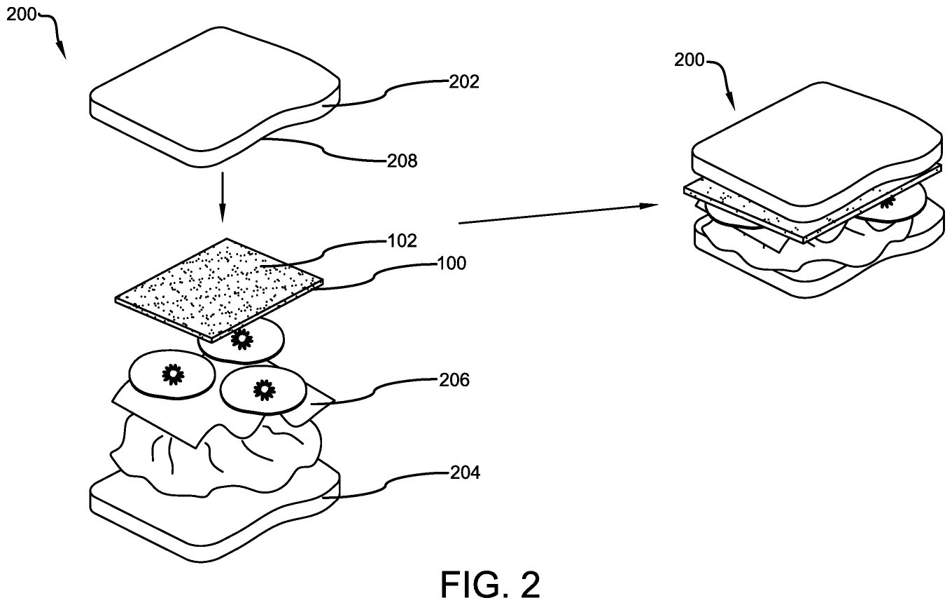

FIG. 2 illustrates a perspective view of a sandwich product having the potato chip of FIG. 1 as a layer therein in accordance with the disclosed architecture. The sandwich product 200 in the present embodiment includes a top bread 202, a bottom bread 204, a meat stack 206, and the potato chip 100 positioned between the meat stack 206 and top bread 202. The top surface 102 makes a face-to-face relation with the bottom surface 208 of the top bread 202 and the bottom surface 104 makes a face-to-face relation with the meat stack 206. The potato chip 100 is designed and dimensioned not to exceed a perimeter of the top bread 202 and the bottom bread 204. More specifically, the potato chip 100 is configured to occupy a substantial portion (up to 98%) of the surface area of the bread portions 202, 204, while conforming to or modeling the perimeter of the bread portions 202, 204 without surpassing it, resulting in a desirable sandwich chip-to-bread ratio and without any overhang or protrusion, thereby maintaining an aesthetically pleasing appearance and facilitating a consistent distribution of ingredients across all portions of the sandwich 200.

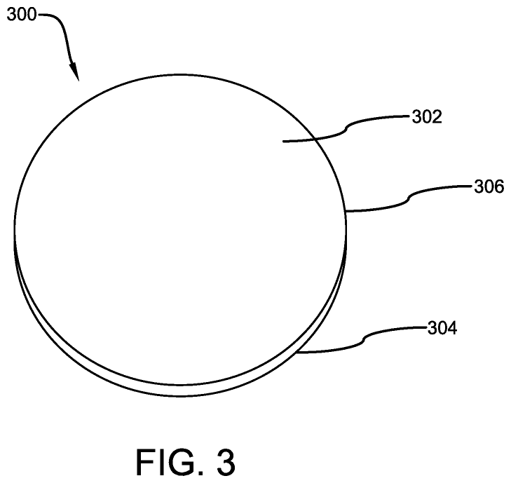

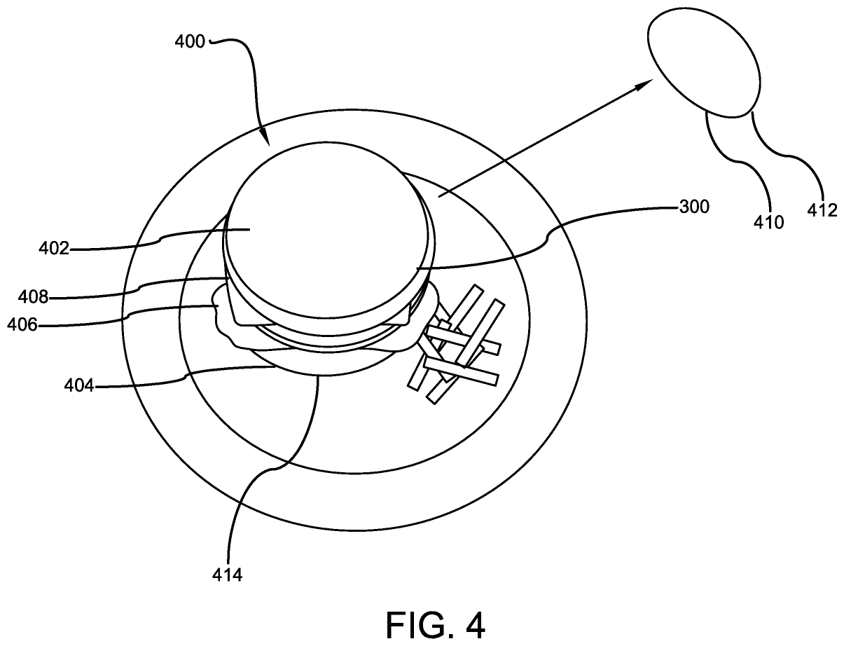

FIG. 3 illustrates a perspective view of another embodiment of the sandwich or bread-sized potato chip of the present invention in accordance with the disclosed architecture. For the purposes of illustration, the potato chip 300 is intended for use with hamburgers and shown as generally circular and is substantially flat and has uniform thickness. The potato chip 300 has a top surface 302 and an opposite and identical bottom surface 304. The potato chip 300 conforms to, or models, the shape of a hamburger bun and the peripheral edge 306 of the potato chip 300 is designed to not exceed the outer edge of the bun as illustrated in FIG. 4. The chip 300 is made of potato paste and can be flavored with any flavor such as classic salted, sour cream and onion, barbecue, cheese and onion, spicy jalapeno, ranch, salt and vinegar, chili cheese, honey mustard, garlic and herb, truffle, smoky bacon, wasabi, dill pickle, hot and spicy, and more.

FIG. 4 illustrates a perspective view of a hamburger product having the potato chip of FIG. 3 as a layer therein in accordance with the disclosed architecture. The hamburger product 400 in the present embodiment includes a top bun 402, a bottom bun 404, a meat stack 406, a cheese slice 408, and the potato chip 300 positioned between the cheese slice 408 and top bun 402. The top surface 302 makes a face-to-face relation with the bottom surface 410 of the top bun 402 and the bottom surface 304 makes a face-to-face relation with the cheese 408, or meat (not illustrated). The potato chip 300 is designed and dimensioned not to exceed outer edges 412, 414 of the top bun 402 and the bottom bun 404, respectively.

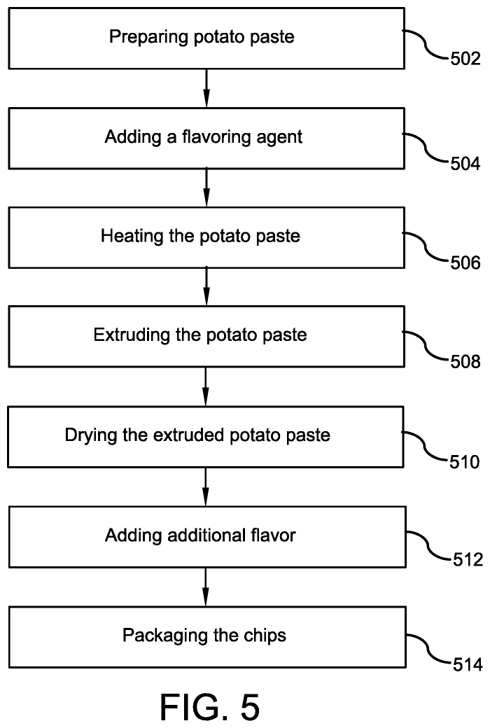

FIG. 5 illustrates a flow diagram depicting a process of making sandwich or bread/bun-sized snack potato chips of the present invention in accordance with the disclosed architecture. Initially, a potato paste is prepared by mixing different ingredients including potato flour, water, and other ingredients such as salt, oil, and spices (Step 502). Then, a flavoring agent depending on the requirement is added to the potato paste (Step 504). Thereafter, the potato paste is heated to around 60-150° C. for activating the potato flour and to form a smooth and consistent paste (Step 506).

Then, depending on the snack item for which the potato chip is to be made, the potato paste is extruded through a die or mold to give it the desired shape and size (Step 508). The extrusion process can be performed at around 70-200° C. In the next step, the extruded chips are then dried in an oven or a fryer to remove excess moisture and to give them a crispy texture (Step 510). The drying process is performed at low humidity, which helps to evaporate the moisture and create a crispy texture.

Then, for additional flavor, potato chips are seasoned with various flavors such as barbecue, salt and vinegar, cheese, or any other flavor (Step 512). Finally, the chips are packaged in bags or stacked in containers, which are sealed to ensure freshness and prevent contamination (Step 514). The packaging may also include branding, nutritional information, and other relevant details about the product.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sandwich or bread/bun-sized snack potato chip”, “sandwich potato chip”, “potato chip”, “snack potato chip”, and “chip” are interchangeable and refer to the bread-sized potato chip 100, 300 of the present invention.

Notwithstanding the forgoing, the bread-sized potato chip 100, 300 of the present invention can be of any suitable size and configuration as is known in the art without affecting the overall concept of the invention, provided that it accomplishes the above stated objectives. One of ordinary skill in the art will appreciate that the bread-sized potato chip 100, 300 as shown in the FIGS. are for illustrative purposes only, and that many other sizes and shapes of the bread-sized potato chip 100, 300 are well within the scope of the present disclosure. Although the dimensions of the bread-sized potato chip 100, 300 are important design parameters for user convenience, the bread-sized potato chip 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snack chip for layering on a sandwich, the snack chip comprising:
a one-piece potato chip having an area slightly smaller than an area of a sandwich bread;
wherein said one-piece potato chip having a top surface and a bottom surface;
wherein said top surface and said bottom surface are parallel and include the same texture and taste; and
further wherein said one-piece potato chip including potato paste.

2. The snack chip for layering on a sandwich of claim 1, wherein said area of said one-piece potato chip is defined by a rectangular shape having dimensions selected from a group consisting of a 3.5″×3.0″, a 3.5″×3.5″, and a 4.0″×4.0″.

3. The snack chip for layering on a sandwich of claim 1, wherein said area of said one-piece potato chip is defined by a circular shape having dimensions selected from a group consisting of a 3.0″ diameter, a 3.5″ diameter, and a 4.0″ diameter.

4. The snack chip for layering on a sandwich of claim 1, wherein said one-piece potato chip having a varied thickness from 0.5″ to 0.75″ proximal to a central area of said one-piece potato chip.

5. The snack chip for layering on a sandwich of claim 4, wherein said one-piece potato chip having said varied thickness from 0.25″ to 0.5″ proximal to an edge area of said one-piece potato chip.

6. The snack chip for layering on a sandwich of claim 5, wherein said central area is denser than said edge area.

7. The snack chip for layering on a sandwich of claim 1, wherein said one-piece potato chip having a uniform thickness throughout an entire volume area of said one-piece potato chip.

8. The snack chip for layering on a sandwich of claim 7, wherein said potato paste having a flavoring selected from a group consisting of a salt, a sour cream and onion, a barbecue, a cheese and onion, a spicy jalapeno, a ranch, a salt and vinegar, a chili cheese, a honey mustard, a garlic and herb, a truffle, a smoky bacon, a wasabi, a dill pickle, and a hot and spicy.

9. The snack chip for layering on a sandwich of claim 8, wherein said one-piece potato chip having an area substantially equal to the area of a sandwich bread.

10. The snack chip for layering on a sandwich of claim 1 wherein said one-piece potato chip is at least one layer of a sandwich product, and further wherein the sandwich product having a top bread layer, a bottom bread layer, a meat stack, and said one-piece potato chip layer.

11. The snack chip for layering on a sandwich of claim 10, wherein said one-piece potato chip layer positioned between said meat stack and said top bread layer.

12. A snack chip for layering on a sandwich, the snack chip comprising:
a one-piece potato chip having an area substantially equal to an area of a sandwich bread;
wherein said one-piece potato chip having a top surface and a bottom surface;
wherein said top surface and said bottom surface are parallel and include the same texture and taste;
wherein said one-piece potato chip including potato paste;
wherein said one-piece potato chip having a uniform thickness throughout an entire volume area of said one-piece potato chip; and
further wherein said potato paste having a flavoring selected from a group consisting of a salt, a sour cream and onion, a barbecue, a cheese and onion, a spicy jalapeno, a ranch, a salt and vinegar, a chili cheese, a honey mustard, a garlic and herb, a truffle, a smoky bacon, a wasabi, a dill pickle, and a hot and spicy.

13. The snack chip for layering on a sandwich of claim 12, wherein said area of said one-piece potato chip is defined by a rectangular shape having dimensions selected from a group consisting of a 3.5″×3.0″, a 3.5″×3.5″, and a 4.0″×4.0″.

14. The snack chip for layering on a sandwich of claim 12, wherein said area of said one-piece potato chip is defined by a circular shape having dimensions selected from a group consisting of a 3.0″ diameter, a 3.5″ diameter, and a 4.0″ diameter.

15. The snack chip for layering on a sandwich of claim 12, wherein a central area of said one-piece potato chip is denser than an edge area of said one-piece potato chip.

16. The snack chip for layering on a sandwich of claim 12, wherein said one-piece potato chip is at least one layer of a sandwich product, and further wherein the sandwich product having a top bread layer, a bottom bread layer, a meat stack, and said one-piece potato chip layer.

17. The snack chip for layering on a sandwich of claim 16, wherein said one-piece potato chip layer positioned between said meat stack and said top bread layer.

18. A method of making a sandwich potato chip for layering on a sandwich, the method comprising the steps of:
preparing a potato paste having mixed ingredients including a potato flour, a water, a salt, an oil, and a plurality of spices;
adding a flavoring agent to said potato paste;
heating said potato paste to a temperature between 60 degrees C. and 150 degrees C.;
extruding said potato paste through a mold to form a shape of said sandwich potato chip, wherein said extrusion is performed at a temperature between 70 degrees C. and 200 degrees C.; and
drying said sandwich potato chip in a heated environment;
wherein said drying is performed at a low humidity;
wherein said flavoring agent is selected from a group consisting of a salt, a sour cream and onion, a barbecue, a cheese and onion, a spicy jalapeno, a ranch, a salt and vinegar, a chili cheese, a honey mustard, a garlic and herb, a truffle, a smoky bacon, a wasabi, a dill pickle, and a hot and spicy; and
further wherein said sandwich potato chip having an area substantially equal to an area of a sandwich bread.

19. The method of making a sandwich potato chip for layering on a sandwich of claim 18, wherein said area of said sandwich potato chip is defined by a rectangular shape having dimensions selected from a group consisting of a 3.5″×3.0″, a 3.5″×3.5″, and a 4.0″×4.0″.

20. The method of making a sandwich potato chip for layering on a sandwich of claim 18, wherein said area of said one-piece potato chip is defined by a circular shape having dimensions selected from a group consisting of a 3.0″ diameter, a 3.5″ diameter, and a 4.0″ diameter.
